(19) United States
(12) Patent Application Publication
(10) Pub. No.: US 2008/0240251 A1
(43) Pub. Date: Oct. 2, 2008

(54) Method For the Encoding of Wavelet-Encoded Images With Bit Rate Control, Corresponding Encoding Device and Computer Program

(76) Inventors: Patrick Gioia, Servon Sur Vilaine (FR); Sebastien Brangoulo, Rennes (FR)

Correspondence Address: WESTMAN CHAMPLIN & KELLY, P.A., SUITE 1400, 900 SECOND AVENUE SOUTH, MINNEAPOLIS, MN, 55402-3244, US

(21) Appl. No.: 11/791,134

(22) PCT Filed: Nov. 7, 2005
(86) PCT No.: PCT/EP05/55797

§ 371 Date: May 13, 2008

(30) Foreign Application Priority Data
Nov. 19, 2004 (FR) 0412336

(51) Int. Cl. H04B 1/66

(52) U.S. Cl. 375/240.19

(57) ABSTRACT

The disclosure relates to a method of coding at least one still or animated image, in which said image is associated with (i) a basic mesh formed by a set of faces that are defined by a set of vertices and edges and (ii) coefficients in a base of wavelets corresponding to local modifications to the basic mesh, known as wavelet coefficients, wherein the coded data rate is controlled. The method includes the following steps: controlling a first rate of data representative of a basic mesh that meets a first rate criterion; controlling a second rate of data representative of wavelet coefficients according to a second rate criterion; and finally optimizing the coded data rate by controlling the quantification characteristics of the selected wavelet coefficients.

### FIELD OF INVENTION

The field of the invention is that of the encoding of video sequences with a view to their transmission through wire-based or wireless communications networks such as the Internet, mobile radio-communications networks or terrestrial television broadcasting networks of the DVB-T type for example, or from recording carriers such as DVDs, CD-ROMs, floppy disks etc. The invention can also be applied to the storage of video sequences on such carriers, or more generally in data servers.

More specifically, the invention pertains to the control of the bit rate of such a video sequence.

The invention can be applied to techniques implementing second-generation wavelet encoding. In this type of encoding, each image forming the video sequence is represented by a mesh. For the purposes of compression and adaptive broadcasting in particular, this mesh can be decomposed into a second-generation wavelet base, enabling the reduction of the visual information into a basic mesh, and a sequence of wavelet coefficients. These coefficients can represent both spatial information and evolution in time.

Two types of bit rate control can be distinguished, depending on the applications: constant bit rate and variable bit rate. The former technique therefore seeks to achieve precise convergence toward the target bit rate and will be used in particular for still images. In the latter technique, the bit rate may be adapted for example to the complexity of the image to be processed.

More specifically, over-consumption is permitted for scenes particularly difficult to encode (heavy motions, a great deal of textural information etc) and under-consumption is permitted when the scene is simpler to encode (with fewer motions or no motions, still images etc).

With the development of novel transmission networks (xDSL, mobiles using GPRS and UMTS etc), the techniques of digital video sequence compression must adapt to the heterogeneity of the networks, as well as to possible fluctuations in quality of service (QoS) over time. Taking all these factors into consideration at the video encoding level should give the ultimate user optimum visual quality.

The invention falls within this framework.

### PRIOR ART

The use of mesh encoding and second-generation wavelets has already been the subject of many publications, in particular by the inventors of the present patent application. The principles of this encoding are recalled in the appendix. An advantageous encoding technique taking account of the differences between the successive images is presented for example by S. Bangoulo and P. Gioia, in “An adaptive video coder using saliency and second generation wavelets”, Iasted Sixth conference on Signal and Image Processing, Honolulu, Hi., August 2004, pages 286 to 291.

### DRAWBACKS OF THE PRIOR ART

The prior art techniques presented especially in this document allow for no bit rate control or control of the quality of the encoded images.

Naturally, it is possible to conceive of controlling the bit rate by acting on the number of wavelet coefficients and by eliminating, as the case may be, those coefficients that have a reduced visual impact. However, it appears that, in practice, this technique is not efficient and doesn't able a sufficient level of quality to be maintained.

### GOALS OF THE INVENTION

It is a goal of the invention to overcome these drawbacks of the prior art, and propose a method for the control of bit rate and distortion that is well suited to mesh and wavelet encoding.

It is another goal of the invention to provide a technique of this kind that is simple to implement and does not necessitate any particular preliminary adaptation of the encoding as described for example in the above-mentioned document.

In other words, it is a goal of the invention to provide a technique of this kind that enables control of the final bit rate by the user while at the same time optimizing the final visual distortion.

### ESSENTIAL CHARACTERISTICS OF THE INVENTION

These goals, as well as others that shall appear more clearly here below are achieved by means of a method for the encoding of at least one still or moving image, said image being associated with a basic mesh formed by a set of facets that are defined by a set of vertices and edges and with coefficients in a base of wavelets corresponding to local modifications of said basic mesh, known as wavelet coefficients.

According to the invention, this method implements an encoded data bit rate control, according to the following steps:
control of a first data bit rate representing a basic mesh meeting a first bit rate criterion;
control of a second data bit rate representing wavelet coefficients according to a second bit rate criterion;
final optimizing of the encoded data bit rate by control of characteristics of quantification of said selected wavelet coefficients.

Thus, the bit rate control is done at a twofold level (the basic mesh level and the wavelet coefficient level, thus optimizing the bit rate/distortion ratio).

Advantageously, said encoded data bit rate control implements the following steps:
obtaining a desired target bit rate for said encoded data, and determining a corresponding intermediate bit rate representing said target bit rate before a final encoding of data compression;
determining a basic mesh whose transmission bit rate is lower than said intermediate bit rate;
determining wavelet coefficients with a level of refinement such that the transmission bit rate of said basic mesh and said wavelet coefficients is higher than said intermediate bit rate;
quantification of said wavelet coefficients, with a level of quantification enabling said intermediate bit rate to be attained at least approximately.

Thus, the target bit rate is approached by framing so that this target is obtained as precisely as possible, and in boundarying distortion.

According to a preferred embodiment, a range of values defined by a lower boundary and an upper boundary is thus associated with said algorithm target bit rate, said lower boundary being exploited by said step for determining a basic mesh by successive iterations so that the corresponding transmission bit rate is close to said lower boundary, and said upper boundary being exploited by said step for determining wavelet coefficients so that the corresponding bit rate is close to said upper boundary.

Said range of values is for example of the order of −50% to +50% of said intermediate bit rate.

According to a particular embodiment, the ratio between said target bit rate and said intermediate bit rate may range from 10 to 50. Its value may be for example 20.

Preferably, a user may parameterize at least one of the following aspects:
target bit rate;
desired final PSNR;
mode of encoding, i.e. constant bit rate encoding or variable bit rate encoding.

This enables the user (on the encoding side and/or decoding side) to choose the parameters of the processing as a function of the characteristics linked to the needs and/or resources available.

According to an advantageous embodiment of the invention, said quantification step comprises the following sub-steps:
hierarchical organization of said wavelet coefficients according to a criterion of importance;
distribution of said wavelet coefficients over at least two bit planes, said bit planes being organized by order of importance;
quantification of said wavelet coefficients by successive iterations of a path of said bit planes until a desired bit rate is attained, a current bit rate being re-computed at each iteration in taking account of a criterion of quality of reconstruction of each image.

The optimization relates not only to the bit rate of the wavelet coefficients but also to their selection in order to process the most significant ones by priority.

Preferably, in said optimization step, the encoded data bit rate is variable, depending on a piece of information representing the complexity of an image to be encoded.

This embodiment is of course designed for image sequences. It can also be planned that the final bit rate will be fixed and imposed.

According to a particular embodiment, said final compression encoding comprises an entropic encoding. This technique provides for a big reduction of the bit rate, for example by a factor of 20.

The invention also relates to a device for the encoding of at least one still or moving image, comprising means to control the bit rate of encoded data comprising, for example, the following grouped together in a processor driven by an adapted program:
means to control a first data bit rate representing a basic mesh meeting a first bit rate criterion;
means to control a second data bit rate representing wavelet coefficients according to a second bit rate criterion;
means for a final optimizing of the bit rate of encoded data, by control of characteristics of quantification of said selected wavelet coefficients.

Such a device may be autonomous or integrated into a transmission device, a server, a storage device etc.

The invention also relates to a computer program product comprising program code instructions recorded on a data carrier that can be used in or by a computer, controlling encoding means, for example integrated into the device presented here above. Such a program comprises computer-readable programming means to perform:
a control of a first data bit rate representing a basic mesh meeting a first bit rate criterion;
a control of a second data bit rate representing wavelet coefficients according to a second bit rate criterion;
a final optimizing of the bit rate of encoded data, by control of characteristics of quantification of said selected wavelet coefficients.

These programs are implemented or designed to be implemented in devices as described here above and/or stored in any appropriate carrier.

### LIST OF FIGURES

Other features and advantages of the invention shall appear more clearly from the following description of a preferred embodiment of the invention, given by way of a simple and non-restrictive illustrative example, and from the appended drawings of which:

FIG. 1 is a simplified flowchart introducing the essential aspects of the invention;

FIG. 2 is a detailed flowchart of a preferred embodiment of the encoding method of the invention;

FIG. 3 provides a schematic view of the data stream used in the method illustrated in FIG. 2;

FIGS. 4a and 4b illustrate the principle of creation of the lower and upper boundaries in the method of FIG. 2;

FIG. 5 presents the different steps of a recursive quantification of the bit planes of the method of FIG. 2;

FIG. 6 is a drawing showing the principle of a device implementing the invention.

### DESCRIPTION OF AN EMBODIMENT OF THE INVENTION

As indicated in the introduction, the invention relates to the control of the bit rate of an image sequence, or of an image, encoded by means of a mesh and second-generation wavelets. The main aspects of this encoding technique, known per se, are recalled in the appendix.

The approach of the invention is that of providing a technique to obtain a better compromise between a desired bit rate and the final quality restored. It is therefore a “bit rate/distortion” control method for the encoding of still images and video sequences. This method is performed in two main stages:
a heuristic-based control on the basic mesh, when this mesh is created;
a second control on the wavelet coefficients, during the quantification of these coefficients.

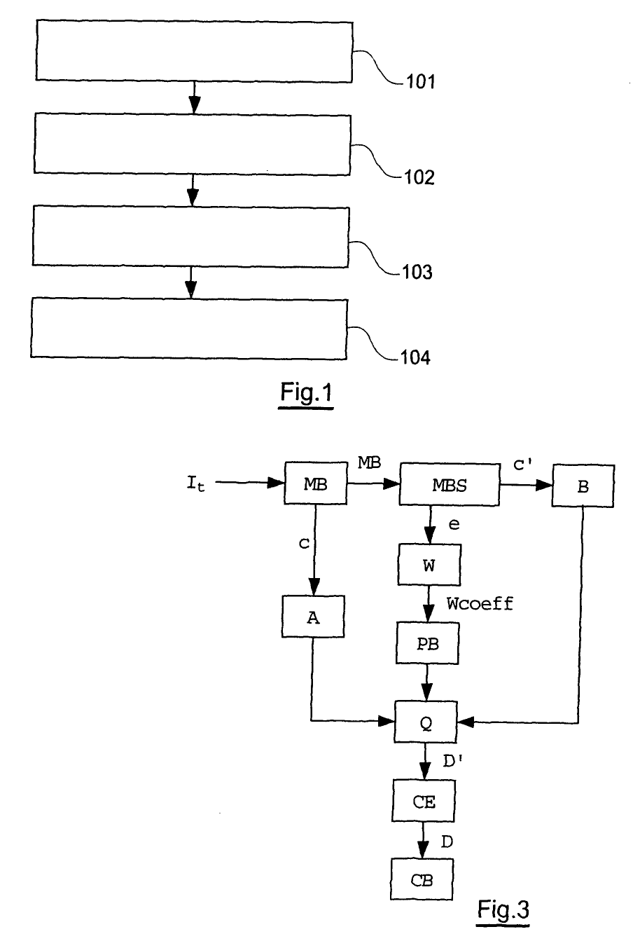

As illustrated in FIG. 1, the method of the invention relies on four successive steps:
step 101: creation of a base mesh by the prior art technique, depending on the bit rate requested by the user;
step 102: creation of a lower boundary and an upper boundary, which will constitute the interval in which the final bit rate will be situated;
step 103: analysis and creation of the wavelet coefficients, then classification of these coefficients in a SPIHT (Set Partitioning In Hierarchical Tree) tree;
step 104: encoding of the coefficients in bit planes and adaptive quantification of these bit planes as a function of the interval obtained and the target bit rate in view.

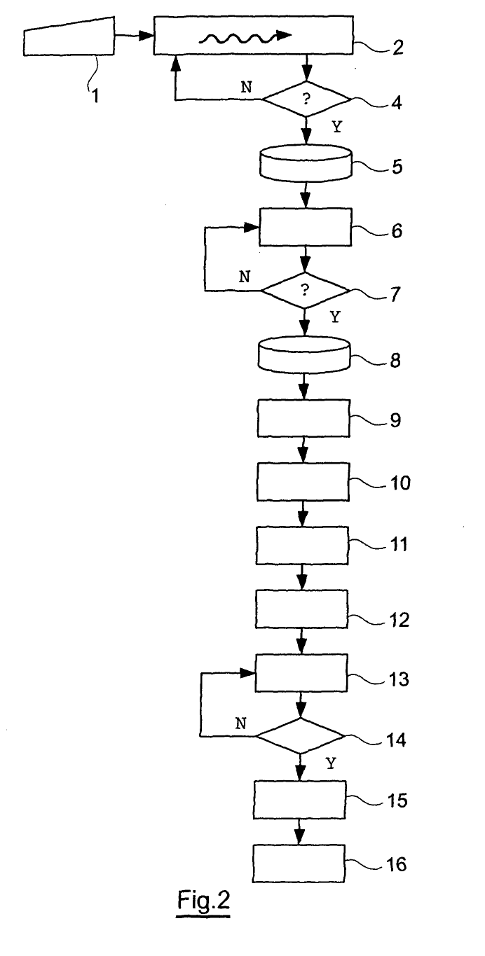

FIG. 2 provides a detailed description of an algorithm of an embodiment of the invention.

At the step 1, the target bit rate D is chosen. This target bit rate may be set by the user or may depend on constraints dictated for example by the terminal or the capacities of a transmission network. The encoding mode, with constant bit rate (CBR) or variable bit rate (VBR), is chosen. This choice will influence the processing since the sequence will not be encoded in the same way.

For a still image, the CBR mode is the only one possible. By contrast, for a video sequence, both the CBR and VBR modes are possible. The VBR mode is used to permit over-consumption of bit rate for scenes or images that are more difficult to encode and in return to permit under-consumption when these scenes or images are simpler to encode.

Once the target bit rate D has been chosen, an algorithm target bit rate D′, which takes account of the final compression that would be performed, for example by entropic encoding, is determined. In the embodiment presented, this entropic encoding provides for compression of the order of 20. The value D′ is therefore fixed as: D′=D/20.

The step 2 of the algorithm is that of a search for the basic mesh, which is done in a manner known per se, for example according to the technique presented in the document already mentioned in the introduction.

The basic mesh is therefore obtained. During the creation of this basic mesh, this basic mesh is augmented recursively by the fusion method or refined recursively by the salient point method, so that bit rate is always below the algorithm target bit rate D′.

The cost of encoding a vertex in the basic mesh is known (about 60 bytes for fusion and 10 bytes for the salient point method in the embodiment represented). This cost, multiplied by the number of vertices present in the basic mesh, gives the lower framing boundary.

A certain margin however has to be kept (for example about 50% of the value of D′) in order to obtain a sufficiently wide framing to adapt the subsequent quantification of the wavelet coefficients and provide for real choice in the distortion of the image.

A lower boundary A is therefore chosen, for example such that A=D′−50%. This boundary is of course given by way of an example and may be adapted to the size of the stream.

A test is then performed, in the step 4, on the minimum bit rate of the encoded basic mesh. If this minimum bit rate is below the algorithm target bit rate D′, then the method passes to the step 5. If not, it loops back to the step 2.

The step 5 is a step of storage of the basic mesh, which is kept for subsequent transmission. It is the basis of reconstruction of the image as well as the lower boundary of the algorithm target bit rate D′.

At the step 6, this basic mesh is refined. The basic mesh is refined equally on all the triangles in order to obtain the maximum bit rate, i.e. the upper boundary of the framing of D′.

The subdivision method used is a classic 1 to 4 subdivision with a given level k. The level k is determined by the algorithm, which makes a test at each level to ascertain that the maximum bit rate is truly above the algorithm target bit rate D′.

This upper boundary B can be chosen such that B=D′+50%.

The refining is advantageously done by the method described in the document mentioned here above in the introduction. This method is an adaptive hierarchical method: certain triangles are subdivided to the maximum while others are subdivided only to an intermediate level, and some of them are not subdivided.

The step 7 is a test on the final bit rate of the subdivided mesh. If this final bit rate is higher than the algorithm target bit rate D′, the method passes to the next step 8. If not, the method returns to the step 6, to continue the refining operation.

In the step 8, the mesh thus refined is stored in order to be subsequently analyzed.

In the step 9, this refined mesh is analyzed by a second-generation wavelet transform, for example according to the method described in M. Lounsbery and T. DeRose, <<Multiresolution Analysis for Surfaces of Arbitrary Topological types”, ACM Transaction on Graphics, 1994.

Once this mesh is analyzed, a series of wavelet coefficients is obtained at the step 10. These coefficients, without quantification, show a bit rate ranging from D′−50% to D′+50%.

These coefficients are then classified in the step 11 in a SPIHT tree according to the technique described for example in A. Said and W. Pearlman, “A new, fast, and efficient image codec based on set partitioning in hierarchical trees”, IEEE Trans. Circuits Sits. Video Techno. 6 (June 1993), pages 243 to 250.

This classification can be used to find out which coefficients are significant and which coefficients are less significant.

In the step 12, the wavelet coefficients are encoded on bit planes, according to the method proposed by Said and Pearlman. This technique is illustrated in FIG. 5, commented upon in greater detail here below. The coefficients are classified in planes, starting from the most significant bit plane and going toward the least significant bit plane. At each iteration, the corresponding image is reconstructed and its PSNR (“Peak Signal Noise Ratio”) is computed. Thus, it is also possible to lay down a PSNR instead of a target bit rate during the control by the user at the step 1, and it is also possible to combine both aspects.

The step 15 is therefore a step of entropic encoding of the stream showing the algorithm target bit rate D′ to obtain a bit rate D. This compression can be done by means of a dictionary method or by a Huffman algorithm. In the embodiment described, an LZSS type dictionary method is used. This technique is described especially in J. Ziv and A. Lempel: “A Universal Algorithm for Sequential Data Compression”, (IEEE Trans. on Information Theory, Vol. IT-23, NO. 3, pp. 337-343, 1977).

Finally, at the step 16, the bit stream at the target bit rate D is created. The generation of the stream may be obtained, for example, according to the technique presented in the document cited in the introduction.

The steps 13 and 14 converging toward a final bit rate D′ may be replaced by a variable bit rate (VBR) encoding method. As already indicated, this method permits over-consumption in the case of a scene that is difficult to encode (for example for a video with heavy motions) and under-consumption in a scene that is simpler to encode (with a fixed plane or light motions). This enables the maintaining of a mean bit rate requested by the user during the encoding, while remaining more flexible than in the case of encoding at constant bit rate.

This method has the advantage of offering quality that is more constant during the viewing of the content. In this case, the same approach will be used, except that the algorithm will keep a floating frame for the bit rate rather then converge toward this bit rate. The quantification of the coefficients will be therefore more flexible in the case of over-consumption and more rigid in the case of under-consumption.

A psycho-visual criterion (for example the PSNR) is used to determine the need to augment or reduce the quantification while at the same time remaining within the framing fixed by the algorithm. In the case of a simple scene, there will be for example:

An≦D′n<Bn,

and in the case of a complex scene:

Ak<D′k<Bk

The final bit rate desired by the user is D, such that D=D′/20.

We will therefore have:

$$D = \frac{20}{L} {\sum }_{i = 0}^{L} {D}_{i}^{′}$$

where L is the number of images of the sequence or of the group of images processed.

FIG. 3 illustrates the data streams handled in the context of FIG. 2 and the corresponding bit rates.

From the image Iₜ, there is the basic mesh MB available which will enable the boundary A to be determined. The basic mesh MB is then refined (MBS) and compared with the boundary B. After transformation of the wavelet coefficients W and then their distribution in bit planes (PB), the data are quantified (Q). This quantification is framed by the boundaries A and B.

At output of this quantification, a bit rate D′ is obtained and, after entropic encoding (CE) there is a bit rate D from which the final bitstream (CB) is created.

In this FIG. 3, e represents the number of the vertices of the basic mesh, c the number of relevant wavelet coefficients, after selection, and c′ the total number of wavelet coefficients.

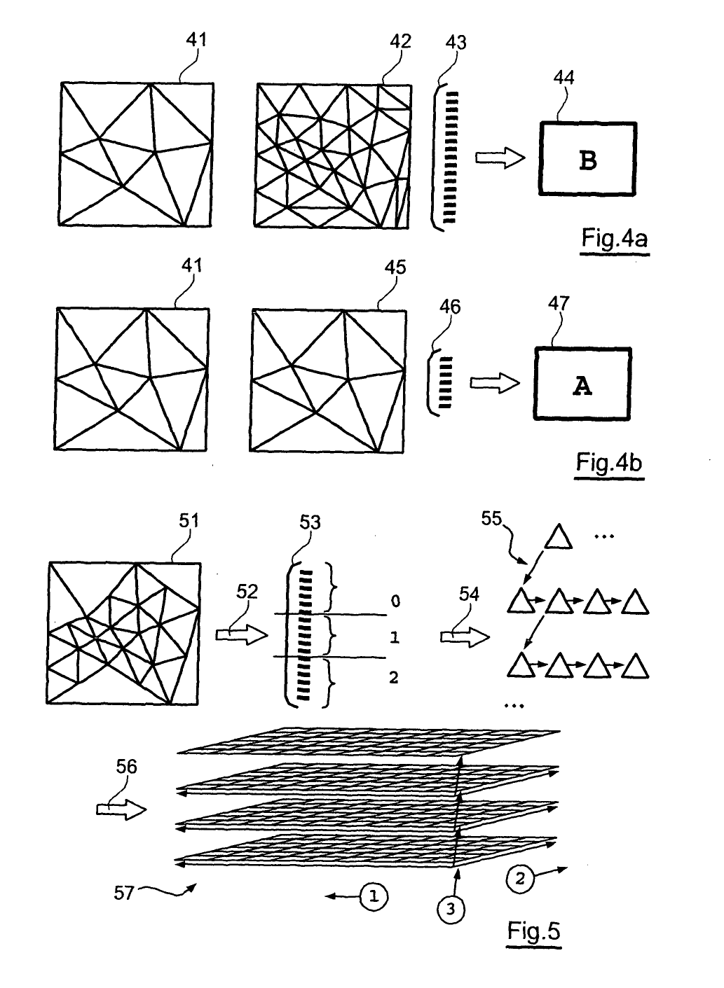

FIGS. 4a and 4b illustrate the principle of the creation of the lower and upper boundaries A and B.

From a basic mesh of an image 41, the mesh is subjected to a total subdivision 42 at the level k, making it possible to obtain a first list of vertices of the mesh 43. This enables the setting of the upper boundary 44 of the bit rate D.

At the same time, as shown in FIG. 4b, from a same basic mesh 41, no subdivision 45 of the mesh is performed. This gives a list of vertices 46 that is greatly reduced as compared with the list of vertices 43. The lower boundary A referenced 47 of the bit rate is deduced from this.

After these two values A and B are obtained, it is ensured that the bit rate D′ between these two boundaries is preserved.

FIG. 5 illustrates the principle of the recursive quantification of the bit planes, corresponding to the steps 9 to 14 of FIG. 2.

Starting from a semi-regular mesh 41, the wavelet analysis 42 is performed, delivering a series of coefficients 53, organized in levels 0, 1 and 2. These coefficients are then distributed (54) in a SPIHT tree 55.

Then, these coefficients are quantified (56) and arranged in bit planes 57.

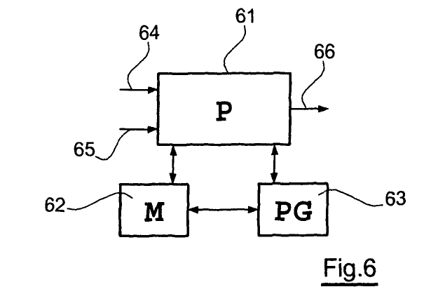

FIG. 6 is a drawing showing the principle of an encoding device implementing the invention. It may be in particular an encoder implemented in a signal transmission device with a view to reducing its bit rate before transmission, or again a data storage system with a view to reducing the size of the stored files.

The device includes processing means 61, for example in the form of a microprocessor, data storage means 62, for example in the form of a RAM, in which are stored the basic mesh and the wavelet coefficients (especially during the steps 5 and 8) and a program 63 controlling the microprocessor 61 to implement the about-described method.

Thus, the processor 61 receives a request 64 representing the desired bit rate and the type of encoding, and the images 65 to be processed. It stores the temporary information in the memory 62 and carries out the processing described here above according to the program instructions 63. It delivers an encoded signal 66 at the fixed target bit rate.

### APPENDIX

The prior art techniques for the mesh encoding of still images or video sequences rely on the use of hierarchical meshes that are associated with the images to be encoded. Thus, let us consider a still image, for example one encoded in grey levels (the same technique applies to a chrominance-encoded image for example). The image may be considered to be a discretized representation of a parametrical surface. It is therefore possible to apply any unspecified meshing either to a zone of the image or to the entire image. By hierarchical subdivision (which may or may not be adaptive), this mesh is made to evolve regularly or irregularly. There is thus a “hierarchy” available by the subdivision of the mesh only in those regions of the image in which the computed error is above a predetermined threshold. A general perception of the mesh-based techniques is also presented in the document ISO/IEC (ITU-T SG8) JTC1/SC29 WG1 (JPEG/JBIG), JPEG2000 Part I Final Committee Draft, Document N2165, June 2001.

For their part, the second-generation wavelets implemented in the context of the present invention constitute a novel transformation coming from the world of mathematics.

This transformation was introduced firstly by W. Dahmen (“Decomposition of refinable spaces and applications to operator equations”, Numer. Algor., N°5, 1993, pp. 229-245 and J. M. Carnicer, W. Dahmen and J. M. Pena (“Local decomposition of refinable spaces”, Appl. Comp. Harm. Anal. 3, 1996, pp. 127-153, and then developed by W. Sweldens (“The Lifting Scheme: A Construction of Second-Generation Wavelets”, November 1996, SIAM Journal on Mathematical Analysis, and W. Sweldens & P. Schröder (“Building Your Own Wavelet at Home”, Chapter 2, Technical report 1995, Industrial Mathematics Initiative.

These wavelets are built from an irregular subdivision of the analysis space and are based on a weighted and averaged interpolation method. The vector product habitually used on L²(R) becomes a weighted internal vector product. These wavelets are particularly well suited to analyses on compact supports and on the intervals. However, they preserve the properties of the first-generation wavelets, namely efficient time/frequency localization and high computation speed because they are built around the lifting method explained here above.

M. Lounsbery, T. DeRose, and J. Warren in “Multiresolution Analysis for Surfaces of Arbitrary Topological Type”, ACM Transactions on Graphics, 1994 have envisaged the application of these wavelets to any unspecified surface structure. In the context of the present invention, these wavelets are applied to a mesh constituting a surface whose topology may be any topology whatsoever.

To make an exact definition of these second-generation wavelets, we may first recall the properties that these wavelets have in common with what are called first-generation wavelets, and then indicate the additional properties that are possessed by these second-generation wavelets and are exploited, for example, in the context of the present invention.

### Properties Common to First-Generation and Second-Generation Wavelets:

P1: the wavelets form a Riez base on L₂(R), as well as a “uniform” base for a large variety of function spaces, such as the Lebesgue, Lipchitz, Sobolev and Besov spaces. This means that any function of the spaces cited may be decomposed into wavelet base, and this decomposition will converge uniformly in terms of norm (the starting space norm) toward this function.

P2: the decomposition coefficients on the uniform base are known (or may be found simply). Either the wavelets are orthogonal or the dual wavelets are known (in the bi-orthogonal case).

P3: the wavelets, as well as their dual counterparts have local properties in terms of space and frequency. Certain wavelets even have compact support (the present invention preferably but not exclusively uses such wavelets). The properties of frequency localization flow directly from the regularity of the wavelet (for the high frequencies) and the number of zero polynomial moments (for the low frequencies).

P4: the wavelets may be used in multiresolution analysis. This leads to FWT (Fast Wavelet transform,), making it possible to pass from the function to the wavelet coefficients in “linear time”.

Additional Properties Characterizing the Second-Generation Wavelets:

Q1: whereas the first-generation wavelets give bases for functions defined on Rⁿ, certain applications (data segmentation, solutions of the partial derivative equations on general domains, or applications of the wavelets to a mesh with arbitrary topology etc), require wavelets defined on arbitrary Rⁿ domains, such as curves, surfaces or varieties;

Q2: the diagonalization of the differential forms, the analysis of the curves and surfaces, and weighted approximations necessitate a base adapted to the weighted measurements. However, the first-generation wavelets give bases only for the spaces with invariant measurements by translation (typically, the Lebesgue measurements);

Q3: many real problems necessitate adapted algorithms for data with irregular sampling, while first-generation wavelets enable analysis only on regularly sampled data.

Thus, to summarise the construction of the second-generation wavelets, the following principles can be put forward.

During the multiresolution analysis, it is assumed that the traditional space in which the scale functions develop are the values of Vₖ, such that:

$$\overline{{⋃}_{k} {V}_{k}} = {L}_{2} ( )$$

The analysis space is enlarged by taking a Banach space (referenced B). We therefore have, for the second-generation wavelets:

$$\overline{{⋃}_{k} {V}_{k}} = B$$

A scalar product is defined in the Banach space, in the sense of the distributions, this scalar product enabling the dual spaces to be redefined. The condition of refinement becomes (in matrix form):

φ^{k-1}=Pφ^{k}

where P is any unspecified matrix.

1. Encoding method for the encoding of at least one still or moving image, said image being associated with a basic mesh formed by a set of facets that are defined by a set of vertices and edges and with coefficients in a base of wavelets corresponding to local modifications of said basic mesh, called wavelet coefficients wherein the method implements an encoded data bit rate control, according to the following steps:
controlling a first data bit rate representing a basic mesh meeting a first bit rate criterion;
controlling a second data bit rate representing wavelet coefficients according to a second bit rate criterion; and
final optimizing of the encoded data bit rate by control of characteristics of quantification of selected wavelet coefficients.

2. Encoding method according to claim 1, wherein said encoded data bit rate control implements the following steps:
obtaining a desired target bit rate for said encoded data, and determining a corresponding intermediate bit rate representing said target bit rate before a final data compression encoding;
determining a basic mesh whose transmission bit rate is lower than said intermediate bit rate;
determining wavelet coefficients with a level of refinement such that the transmission bit rate of said basic mesh and said wavelet coefficients is higher than said intermediate bit rate; and
quantifying said wavelet coefficients, with a level of quantification enabling said intermediate bit rate to be attained at least approximately.

3. Encoding method according to claim 2, wherein:
a range of values defined by a lower boundary and an upper boundary is associated with said algorithm target bit rate,
said lower boundary being exploited by said step of determining a basic mesh by successive iterations so that the corresponding transmission bit rate is close to said lower boundary, and
and said upper boundary being exploited by said step of determining wavelet coefficients so that the corresponding bit rate is close to said upper boundary.

4. Encoding method according to claim 2, wherein the method enables a user to parameterize at least one of the following aspects:
the target bit rate;
desired final PSNR; or
mode of encoding, wherein the mode comprises constant bit rate encoding or variable bit rate encoding.

5. Encoding method according to claim 2, wherein said step of quantifying comprises the following sub-steps:
hierarchical organization of said wavelet coefficients according to a criterion of importance;
distribution of said wavelet coefficients over at least two bit planes, said bit planes being organized by order of importance; and
quantification of said wavelet coefficients by successive iterations of a path of said bit planes until a desired bit rate is attained, a current bit rate being re-computed at each iteration in taking account of a criterion of quality of reconstruction of each image.

6. Encoding method according to claim 1 wherein, in said optimizing step, the encoded data bit rate is variable, depending on a piece of information representing the complexity of an image to be encoded.

7. Encoding method according to claim 2, wherein said final compression encoding comprises an entropic encoding.

8. Device for the encoding of at least one still or moving image, said image being associated with a basic mesh formed by a set of facets that are defined by a set of vertices and edges and with coefficients in a base of wavelets corresponding to local modifications of said basic mesh, known as wavelet coefficients, wherein the device comprises means to control the bit rate of encoded data comprising:
means to control a first data bit rate representing a basic mesh meeting a first bit rate criterion;
means to control a second data bit rate representing wavelet coefficients according to a second bit rate criterion; and
means for a final optimizing of the bit rate of encoded data, by control of characteristics of quantification of said selected wavelet coefficients.

9. Computer program product comprising program code instructions recorded on a data carrier that can be used in or by a computer, controlling an encoder, which encodes at least one still or moving image, said image being associated with a basic mesh formed by a set of facets that are defined by a set of vertices and edges and with coefficients in a base of wavelets corresponding to local modifications of said basic mesh, known as wavelet coefficients, wherein the computer program product comprises computer-readable programming instructions to perform:
a control of a first data bit rate representing a basic mesh meeting a first bit rate criterion;
a control of a second data bit rate representing wavelet coefficients according to a second bit rate criterion; and
a final optimizing of the bit rate of encoded data, by control of characteristics of quantification of said selected wavelet coefficients.
